(19) United States
(12) Patent Application Publication
(10) Pub. No.: US 2026/0161650 A1
(43) Pub. Date: Jun. 11, 2026

(54) PLAN VARIANT

(71) Applicant: SAP SE, Walldorf (DE)

(72) Inventors: Jinyong Lee, Seoul (KR); Joo Young Yoon, Suwon (KR); Ji-won Park, Seoul (KR); Sukhyeun Cho, Incheon (KR); Taehyung Lee, Seoul (KR)

(21) Appl. No.: 18/977,346

(22) Filed: Dec. 11, 2024

(51) Int. Cl. G06F 16/2453; G06F 16/2455

(52) U.S. Cl. CPC G06F 16/24545; G06F 16/24552

(57) ABSTRACT

A system and method including receiving a parameterized query including at least one parameter; determining a selectivity for variant filters associated with the parameterized query, the variant filters having at least a minimum influence threshold on a query plan optimization for the parameterized query; determining, based on the determined selectivity for the variant filters associated with the parameterized query, whether there is a cache hit or a cache miss with a cached query plan and a query plan of the parameterized query; in response to determining there is a cache hit, fetching the cached query plan and executing the cached query plan for the parameterized query; and in response to determining there is a cache miss, compiling and executing the query plan for the parameterized query.

### BACKGROUND

In some conventional database management systems, including some that process structured query language (SQL) queries, a query processor receives a database query wherein a compiler compiles the database query to produce an intermediate form that an optimizer optimizes to generate a query execution plan. In some systems, the query optimizer determines a number of candidate query execution plans based on a received query, estimates the cost of each query execution plan and selects the plan with, for example, the lowest execution cost (i.e., the optimal query plan). An execution engine executes the optimal query plan on the database and returns a corresponding result set. In some systems, in an effort to increase query processing efficiencies and reduce computational overhead, the database management system might store an optimized query plan in a cache memory, wherein a subsequent query received by the system might be matched to the cached optimal query plan and the optimal query plan is retrieved from the cache memory and executed for the subsequent database query. In this way, the cached optimal query plan is reused and the need to optimize a new query plan for the subsequent database query is avoided, thereby saving processing time and resources.

In some previous database management systems, a single “optimal” query plan is cached for all queries, including parameterized queries. However, the optimal query plan for a parameterized query might vary depending on the given parameters (e.g., sets of parameters) for a parameterized query. Given a first parameterized query with its parameters, a system may compile the first parameterized query, generate an “optimal” query plan based thereon, and store the single “optimal” query plan in cache. Thereafter, upon receiving a subsequent parameterized query for processing, the system might use the cached “optimal” query plan for executing the subsequent parameterized query. Notably, depending on the parameters of a subsequent parameterized query, the sole cached query plan generated based on the first parameterized query and its parameters might not be an optimal query plan for the subsequent parameterized query. Accordingly, the query result generated for the subsequent parameterized query using the cached query plan might actually not be optimal for the subsequent parameterized query. As such, the desired increases in processing efficiencies and resources management might not be achieved and the results might also be suboptimal.

Accordingly, it would therefore be desirable to provide a framework or infrastructure to provide multiple query plans for a parameterized query for the execution of the parameterized query, since different parameters for a parameterized query might have a correspondingly different optimal query plan.

### BRIEF DESCRIPTION OF THE DRAWINGS

FIG. 1 is an illustrative block diagram of a system, in accordance with an example embodiment herein;

FIG. 2 is an illustrative process flow to collect variant filters, according to an example embodiment;

FIG. 3 is an illustrative process flow, according to an example embodiment;

FIG. 4 is an illustrative depiction of a cache hit area for two optimized query plans, in accordance with an example embodiment herein;

FIG. 5 is an illustrative depiction of a cache hit area for two optimized query plans and a cache miss for a parameterized query relative to both of the query plans, in accordance with an example embodiment herein;

FIG. 6 is an illustrative depiction of a cache hit area for two optimized query plans, in accordance with an example embodiment herein;

FIG. 7 is an illustrative depiction of a cache hit area for two optimized query plans and a cache hit for a parameterized query relative to one of the query plans, in accordance with an example embodiment herein;

FIG. 8 is illustrative block diagram of a database node, according to some embodiments; and

FIG. 9 is a view of a cloud-based architecture, according to some embodiments.

### DETAILED DESCRIPTION

The following description is provided to enable any person in the art to make and use the described embodiments. Various modifications, however, will remain readily apparent to those in the art.

As noted above, a database management (DBMS) system might operate to process a parameterized database query wherein a single optimized query execution plan (also referred to herein simply as a query plan) is generated based on processing a first parameterized query and its associated parameters and storing the single optimized query generated for the first parameterized query in a cache memory for use in executing subsequent queries against a database. In some aspects for a parameterized query, an optimal query plan might vary depending on the given parameters of the parameterized query. Accordingly, with the goal of producing a query plan that yields an accurate result set to a database query and reduces query processing resource costs, it may be desirable to store multiple query plans for a parameterized query in a cache memory since different parameters for a parameterized query might have a different optimal query plan. That is, for some parameterized queries their optimal query plan might vary depending on the particular parameters for the parameterized query.

Applicants of the present disclosure have realized that similar selectivity vectors for certain query predicates of a parameterized query may correspond to equivalent or substantially similar optimal query plans when compiled against different parameters.

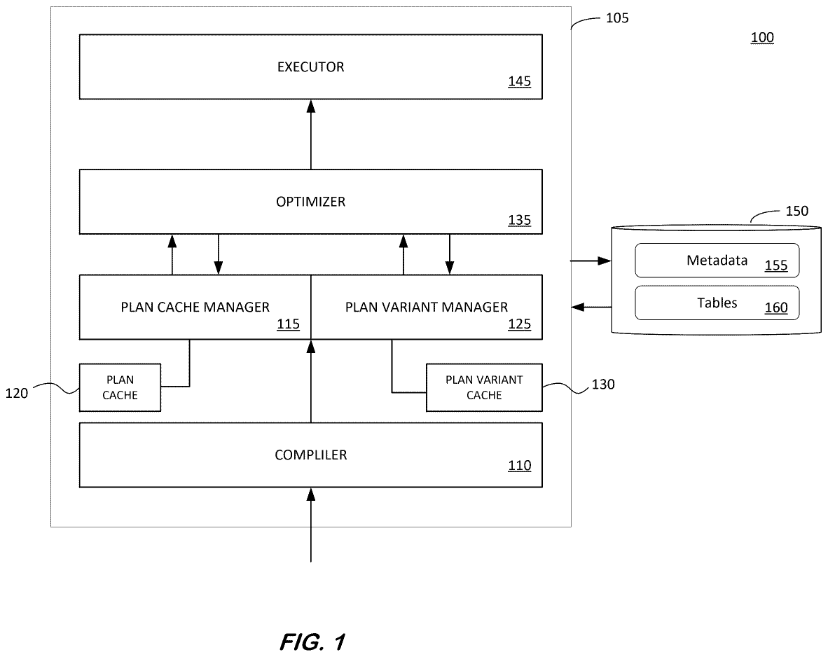

FIG. 1 is an illustrative block diagram of a system 100, in accordance with an example embodiment herein. Each illustrated element of system 100 may be implemented using any suitable combination of computing hardware and/or software that is or becomes known. System 100, including query processor 105, may comprise components of a standalone or distributed (i.e., multi-node) database system. In some embodiments, two or more elements of system 100 are implemented by a single computing device. One or more elements of system 100 may be implemented as a cloud service (e.g., Software-as-a-Service, Platform-as-a-Service).

Compiler 110 receives a parameterized query and determines whether it is a candidate for processing by a plan cache manager 115 and further optimizer 135 that generates a single optimal query plan for a parameterized query and stores the query plan in a plan cache 120 associated with the plan cache manager or a candidate for processing by a plan variant manager 125. In the event a parameterized query is determined by compiler 110 to be a candidate for processing by a plan variant manager 125, in some aspects, optimizer 135 may generate multiple query plans for a parameterized query and store the multiple query plans in plan variant cache 130 associated with the plan cache manager.

In an instance where compiler 110 receives a parameterized query and determines it is not a candidate for processing by the plan variant manager, a query plan for the parameterized query may be determined in another (e.g., conventional) manner by plan cache manager 115, optimized by optimizer 135, and further executed by executor 145 against database 150 to get a result set for the parameterized query.

If the compiler determines the parameterized query is a candidate for processing by plan variant manager 125, the plan variant manager may operate to determine whether there is a cached optimal plan for the parameterized query stored in plan variant cache 130 (i.e., a cache hit). In the event it is determined that there is a cached optimal plan query stored in the plan variant cache, the plan variant manager may proceed to retrieve the cached optimal query plan and further execute the cached optimal plan via the executor (or execution engine) 145 against database 150.

If the parameterized query is determined to be a candidate for processing by plan variant manager 125 and the plan variant manager determines that there is no cached optimal plan for the parameterized query in plan variant cache 130 (i.e., a cache miss), then the plan variant manager may operate to request optimizer 135 to optimize a new query plan for the parameterized query. Executor 140 may continue the processing of the parameterized query by executing the new optimized query plan against database 150 to obtain a result set for the parameterized query.

In some aspects, metadata 155 may define the structure and relationships of tables 160 (e.g., a database schema) as well as statistics that represent various characteristics of the data of tables 160. These statistics may be periodically and dynamically refreshed by a statistics server (not shown) of system 100.

In some aspects, the present disclosure introduces a parameter-sensitive optimization or plan variant process or method that enables the caching of multiple query plans for a parameterized query. As used herein, the multiple plans for each parameterized query may be referred to “variant plans”. A significant aspect of the plan variant process disclosed herein is that similar selectivity vectors for certain query predicates of a parameterized query might likely lead to equivalent or closely similar optimal query plans. As is known in the art, the selectivity of a query predicate refers to the fraction of input rows that satisfy the predicate and is a number between 0 and 1. In some embodiments, the plan variant manager depicted in FIG. 1 might function to identify unique query plans based on the selectivity vector of certain (i.e., carefully chosen) query predicates of the parameterized query. As used herein, these select query predicates of the parameterized query may be referred to as “variant filters”. In some aspects, the variant filters may be anticipated to have a significant influence on a plan optimization decision.

In some embodiments of a plan variant process herein, the process may consider parameterized table filters as the candidates for variant filters. In some embodiments the disclosed plan variant process may be applicable to “equality”, “inequality”, “between”, “like” in predicates consisting of field and arguments without expressions (i.e., COL {=, <, <=, >=, >}?, COL BETWEEN? AND?, COL IN (?, ?, . . . ), or COL LIKE?). In some embodiments, calculated fields and generated fields might not be supported in the plan variant process.

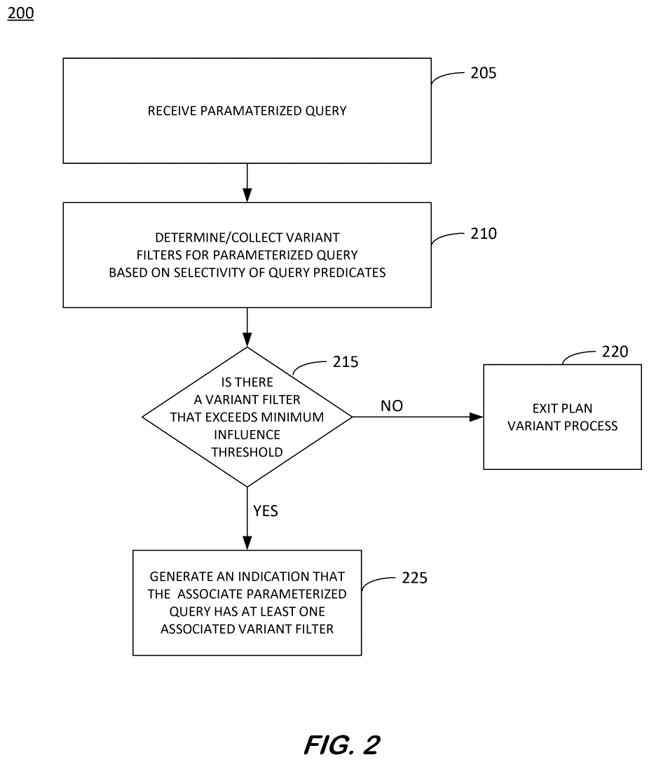

FIG. 2 is an illustrative process flow 200 to collect variant filters of a parameterized query, according to an example embodiment. At a first compilation operation, process 200 receives a parameterized query at operation 205 and collects variant filters at operation 210. The variant filters in this example are those query predicates that are anticipated to have a significant influence on a plan optimization decision based on data distributions of filtered columns. In the instance of a less uniform distribution, the filter(s) will have more selectivity variance for different parameter sets, leading to different optimal plans. At operation 210, a determination is made regarding variant filters for the parameterized query based on a selectivity vector that contains all selectivities of the variant filters.

In some aspects, many different parameters and characteristics of a parameterized query and data related thereto may be considered when deciding or determining candidate query plans. In some aspects, Applicants have realized a limited number of factors might strongly influence query plan optimization. In some embodiments, four (4) types of filters discussed above (e.g., “(in) equality”, “between”, “in”, “like”) are seen as being particularly relevant or effective to query plan optimization. In some embodiments, other filters might be considered and used.

In some embodiments, parameters observed or otherwise determined to most likely yield different optimal plans given different values may be used when collecting variant filters herein. Moreover, a limited number of parameterized filters may be used when choosing cached plans. In some instances, the singularity of the data distribution of the field referred by each parameter is computed. It is noted that as the distribution gets far (i.e., deviates) from a uniform distribution, the selectivity of an equality filter will be far from another and plans will likely be needed for different parameter values for that filter. Based on database table statistics periodically and dynamically maintained in a database management system (e.g., HANA by SAP), Applicants of the present disclosure have realized the following data table statistics may have a significant influence on plan optimization. In some embodiments, the relevant table statistics include a row count, a distinct count, a null count of elements, and the top-K frequent elements along with their frequencies. Using these statistics (and possibly other, different, or substitute statistics in other embodiments), the probability that a dataset is from a uniform distribution may be calculated based on, for example, the chi-squared test.

In some embodiments, for each table filter a chi-squared test statistic and p-value are calculated under the null hypothesis that the corresponding column data is drawn from a uniform distribution.

In some embodiments, the probability may be determined based on the following features, including a fixed column of interest; d is the number of distinct elements; n is the number of non-null elements; and c₁, c₂, . . . , cₖ are frequencies of top-k frequent elements. The frequencies of other elements are assumed to be uniformly

$$c : = \frac{n - Σ {c}_{i}}{d - k} .$$

The expected frequency of the uniform distribution is n/d. Additionally, the chi-square test-statistic

$$t = \sum \frac{{c}_{i} - \frac{n}{d}}{\frac{n}{d}} + \frac{( d - k ) ( c - \frac{n}{d} )}{n - d} .$$

To compute the probability, note that the p-value=P(X>t) where

$$X ∼ {χ}_{k - 1}^{2}$$

(chi-square distribution). With these equations, log(p-value) may be used to differentiate small p-values. It is noted that the lower the p-value is, the less likely the data of this column is from the uniform distribution.

Based on the resulting calculations, the filters with smallest p-values may be selected as variant filters, wherein the selected filters (i.e., variant filters) might be limited to a specified number (e.g., 2-4). However, if no filter passes a threshold for p-values, called minimum influence threshold, at operation 215, then process 200 may conclude there is no variant filter for the parameterized query and exits the plan variant process at operation 220. In some embodiments, processing of the parameterized query may continue from operation 220 to another (e.g., conventional) plan cache process (not shown in FIG. 2).

In the event the parameterized query has at least one variant filter, as determined at operation 210 and verified at operation 215, process 200 may continue to operation 225 where an indication that the parameterized query has at least one variant filter associated therewith is generated. This indication (e.g., a record, data structure entry, flag, message, etc.) may be used to notify the system to prepare to, for example, use the plan variant cache.

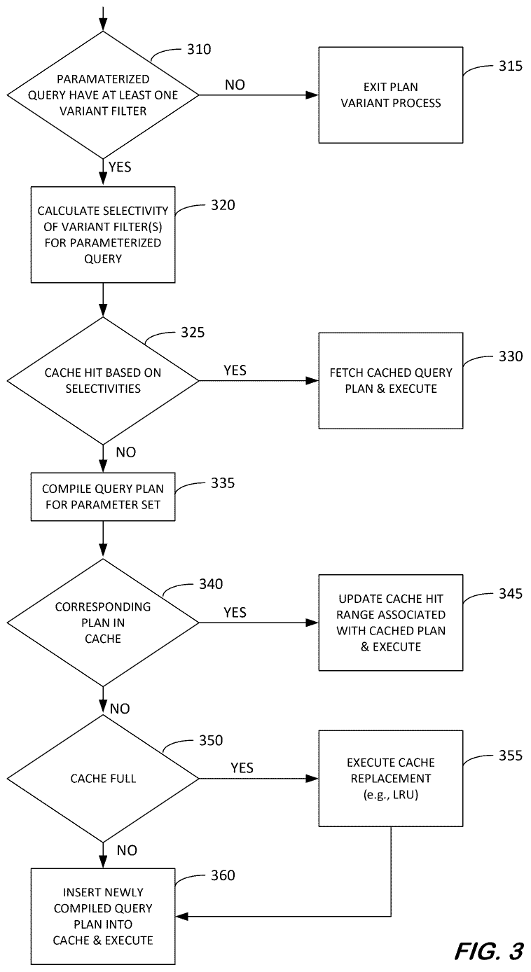

FIG. 3 is an illustrative process flow 300, according to an example embodiment. In particular, process 300 relates to an execution of a parameterized query. Operation 310 may commence after or in response to the execution of operation 225 in FIG. 2. Operation 310 performs a check to determine whether there is at least one variant filter associated with the parameterized query that might invoke usage of the plan variant cache. If it is determined at operation 310 that the parameterized query does not have at least one variant filter associated therewith, process 300 may proceed to terminate at operation 315.

In the instance operation 310 determines the parameterized query has at least one associated variant filter, the selectivity of the variant filter(s) for the parameterized query are calculated at operation 320.

At operation 325, a determination is made regarding a cache hit based on the calculated selectivity vector of the variant filters.

In some embodiments regarding a determination of a cache hit, let the variant filters be denoted as (φ₁, φ₂, . . . , φₘ). When a query is compiled with concrete parameters, the selectivity sᵢ of each φᵢ is estimated. Herein, (s₁, s₂, . . . , sₘ) is referred to as the selectivity vector of variant filters. The selectivity vector is then mapped to a point q=(x₁, x₂, . . . , xₘ) in the cache space where xᵢ=ƒ(sᵢ) for some increasing function ƒ(⋅) up to tuning. For example, ƒ can be an identity function.

Each plan ξ is hence associated with a set S(ξ)={q₁, q₂, . . . } of those m-dimensional points, and its cache hit area is the union of regions R(qᵢ, qⱼ) for all qᵢ, qᵢ∈S(ξ). The region R(qᵢ, qⱼ) is defined by the set of p∈Rₘ satisfying:

$$d ( {q}_{i} , {q}_{j} ) + t \geq e ( d ( {q}_{i} , p ) + d ( {q}_{j} , p ) ) \qquad ( 1 )$$

where t and e are predefined constants, and d is a custom distance function between points. Here, t is a threshold, and e an eccentricity. To define the distance function, let \vec{qᵢqⱼ}=(y₁, y₂, . . . , yₘ) and v=(1/y₁, 1/y₂, . . . , 1/yₘ). Then d(p₁, p₂) is defined by the Euclidean distance between p₁*v and p₂*v where * is the element-wise product, i.e.,

$$d ( {p}_{1} , {p}_{2} ) = {{Σ}_{k = 1}^{m} ( ( {x}_{1 k} - {x}_{2 k} ) / {y}_{k} )}^{2}$$

where pᵢ=(xᵢ₁, xᵢ₂, . . . , xᵢₘ).

The corresponding algorithm for deciding whether a new parameter set falls into one of cached regions is as follows:

Algorithm 1: Cache Region Hit

| 1 | In: a new parameter set | | | | |
|---|---|---|---|---|---|
| 2 | Out: a cached plan if any or no match | | | | |
| 3 | Compute a cache space point p for a new parameter set | | | | |
| 4 | for each cached plan ξ do | | | | |
| 5 | \| | for each qᵢ in S(ξ) do | | | |
| 6 | \| | \| | for each qⱼ in S(ξ) do | | |
| 7 | \| | \| | \| | if d(qᵢ, qⱼ) + t ≥ e(d(qᵢ, p) + d(qⱼ, p)) then | |
| 8 | \| | \| | \| | \| | return ξ |
| | \| | \| | \| | └ | |
| | \| | \| | └ | | |
| | \| | └ | | | |
| | └ | | | | |

| | |
|---|---|
| 9 | return no plan |

Herein, eccentricity, foci, axes, etc., refer to their standard definitions in relation to ellipses. When Formula (1) is of its simplest form where t=0 and d is the Euclidean distance, it becomes an ellipse with the constant e being the eccentricity. To see that, note

$$\vert \vec{{q}_{i} p} \vert + \vert \vec{{q}_{j} p} \vert = 2 a ⟺ e ( \vert \vec{{q}_{i} p} \vert + \vert \vec{{q}_{j} p} \vert ) = 2 ea = 2 c = \vert \vec{{q}_{i} {q}_{j}} \vert$$

where 2a is the length of major axis and 2c is the length between the foci.

Regarding single-point cached plans, for a cached plan ξ with |S(ξ)|=1, its region is precisely R(q₁, q₁), defined by t≥2e(d (q₁, p)), since d(q₁, q₁)=0—so R(q₁, q₁) is a circle centered at p with respect to the distance function d.

The principle behind the threshold t is to give some padding area around the ellipse. A straight-forward example is given by the above paragraph where the region is a circle of radius t: the threshold t adds a padding area around the point q₁. Without t, it might be almost impossible to hit the cache region when the cached plan has only one entry. For regions defined by two different points, t would add a padding area around the ellipses. The distance function d herein is devised to give the padding areas proportional to selectivities.

Returning to FIG. 3, if operation 325 determines there is a cache hit for the parameterized query with a query plan stored in the plan variant cache based on the calculated selectivity vector of the variant filters, then process 300 proceeds to fetch the cached plan from the plan variant cache and execute it for the parameterized query at operation 330.

If operation 325 determines there is not a cache hit for the parameterized query with a query plan stored in the plan variant cache based on the calculated selectivity vector of the variant filters (i.e., the cache does not include the optimal query plan for the given parameter(s) of the parameterized query), then process 300 proceeds from operation 325 to operation 335. At operation 335, the parameterized query is compiled with its associated parameters to generate a new compiled optimized query plan for the given parameters of the parameterized query.

Continuing to operation 340, a determination is made regarding whether the plan variant cache includes a cached query plan the same as the newly compiled optimized query plan for the parameterized query. If there is a same plan in the cache, then the cache hit range of the cached plan is updated and executed as well at operation 345.

In the instance it is determined at operation 340 that there is no same plan in the plan variant cache as the newly compiled optimized query plan for the parameterized query, process 300 may proceed to operation 350. At operation 350, a determination is made regarding whether the plan variant cache is full. If this cache is full, then a cache replacement policy may be invoked at operation 355 to clear some space in the plan variant cache, with process 300 continuing to operation 360 where the newly compiled optimized query plan for the parameterized query is stored in the plan variant cache and further executed. In some embodiments, the cache replacement policy invoked at operation 355 may be a LRU or other cache management technique.

In the event operation 350 determines the plan variant cache is not full, the newly compiled optimized query plan for the parameterized query is stored in the plan variant cache and further executed for the given parameters of the parameterized query at operation 360.

In some aspects, some technical benefits and solutions of the present disclosure include, in some embodiments, solving performance degradation associated with prior and conventional optimize-once by producing multiple optimal plans for parameterized queries; preventing or lessening too frequent recompilation by managing cache hit ranges and stored plans in a progressive manner; and considering and optimizing overhead for a selectivity estimation of all variant filters.

In some aspects, the plan variant process herein (e.g., as implemented by, for example, plan variant manager 125 of FIG. 1) may be configured to progressively cache a new query plan while concurrently controlling the quantity of plans stored in its associated cache (e.g., plan variant cache 130 in FIG. 1) to avoid excessive memory consumption. In some embodiments, the one or more processes, operations, and functions described or attributed to being performed by the plan variant manager of FIG. 1 may be performed or executed by one or more other implementations of different systems, modules, services, applications, etc. In some embodiments, management of the number of query plans stored in cache may be in accordance with one of more cache replacement policies. In one embodiment, the cache replacement policy might include managing existing query plans in the cache on a Least Recently Used (LRU) basis.

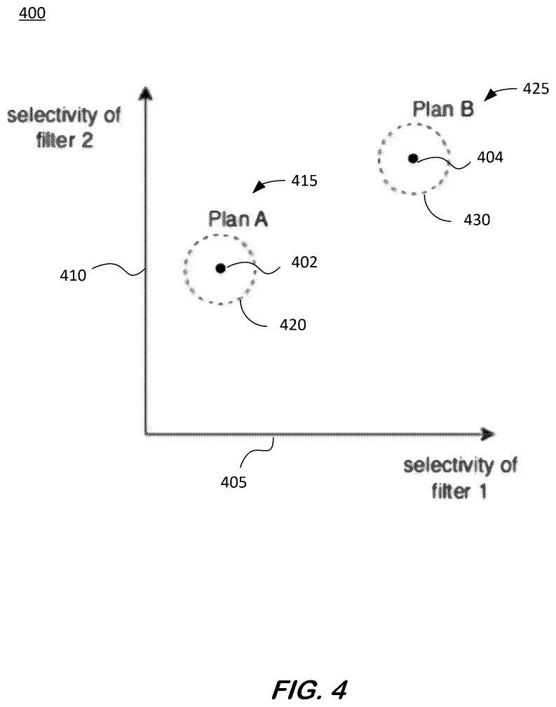

FIGS. 4-7 graphically illustrate various aspects of the plan variant process disclosed herein. In particular, FIGS. 4-7 include illustrative visualizations or representations of exemplary cache hit areas according to some embodiments of the present disclosure.

Regarding a cache hit area generated based on the selectivity vector of certain query predicates (i.e., variant filters) of a parameterized query in accordance with aspects of the present disclosure, a simplified yet illustrative example assumes two parameterized filters (certain or determined as variant filters), resulting in a 2-dimensional representation of a cache hit area. FIGS. 4-7 include illustrative depictions of a 2-dimensional representation of a cache hit area associated with different query plans.

FIG. 4 is an illustrative depiction of a cache hit area for two optimized query plans, in accordance with an example embodiment herein. Referring to the example of FIG. 4, it is assumed that there are two influential parameterized filters where their selectivity vector is depicted by the illustrated two-dimensional graph 400 having a first axis 405 that represents values for a selectivity of a first filter (i.e., a first dimension) and a second axis 410 that represents values for a selectivity of a second filter (i.e., a second dimension) for a parameterized query. Note that if more parameterized filters were considered in the present example, then the dimensions of graph 400 would increase accordingly (e.g., three parameterized filters give a three-dimensional representation, four filters result in a four-dimensional representation, etc.).

As previously discussed herein, the number of parameterized filters considered may be carefully chosen and limited to a predefined quantity when determining the important or influential parameterized filters for determining an optimal query plan.

In the example of FIG. 4, a subject parameterized query includes two (2) variant filters. In this example, for every parameter set provided for the parameterized query, the selectivity of each of the two (2) variant filters of the parameterized query will be calculated and represented as a point (i.e., dot) in graph 400, including the selectivity 402 of the first parameter set and the selectivity 404 of the second parameter set. In the present example, two (2) parameter sets were provided to a system implementing the plan variant process disclosed herein, where each parameter set is compiled to generate the query plans 415 (i.e., Plan A) and 425 (i.e., Plan B). As depicted in FIG. 4, each parameter set forms a cache hit area of its own and has a circular shape. In some aspects, the cache hit equations disclosed hereinabove define the shape and size of the illustrated cache hit area 420 for Plan A and the cache hit area 430 for Plan B.

In some embodiments, a cache hit area for a parameterized query may be determined for a query plan compiled using a single parameter set. For example, see FIG. 4 where each of the cache hit areas 420 and 430 were established based on a single, individual parameter set. A compiled plan with a single parameter set q forms the cache hit area for new parameter value p defined as,

$$T \geq 2 e \cdot d ( q , p ) .$$

and has a circular shape.

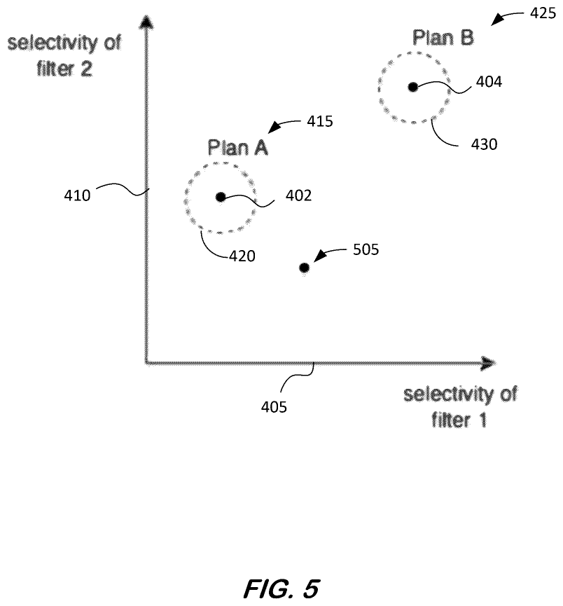

FIG. 5 is an illustrative depiction including the cache hit area for the two optimized query plans of FIG. 4 and a cache miss for a newly received (e.g., third) parameter set of the parameterized query relative to both of the cached query plans of Plan A (415) and Plan B (425), in accordance with an example embodiment herein. As seen in FIG. 5, the selectivity vector of variant filers for newly received parameter set, represented as point 505, does not fall within either of the cache hit areas for Plan A and Plan B. Accordingly, this demonstrates a cache miss for the newly received parameter set. For this example, the parameterized query is compiled with the newly received parameter set to obtain an optimal query plan for the newly received (e.g., third) parameter set. In accordance with other aspects herein (e.g., process 300), this third query plan may be checked against the plan variant cache to determine whether it matches an existing, cached optimal query plan. If there is a same or matching plan in cache, then the cache hit area may be updated (e.g., enlarge its cache hit area) based on the new optimal query plan and executed for the parameterized query and the newly received parameter set. In the instance there is no same or matching plan in cache, then the new optimal plan may be executed to obtain query results for the parameterized query and the newly received parameter set, for which a new cache hit area is created.

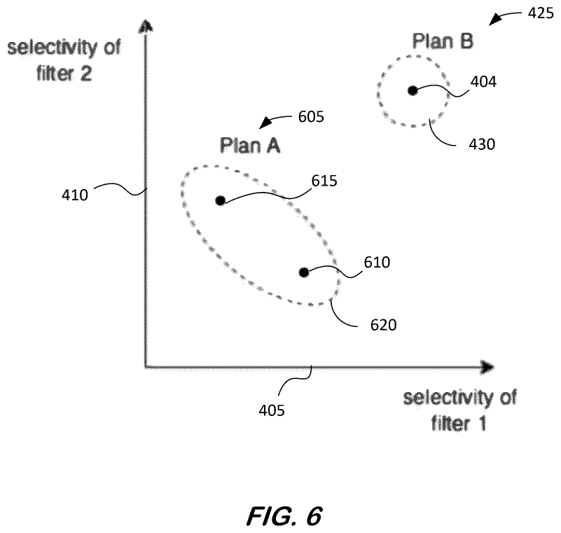

FIG. 6 is an illustrative depiction of a cache hit area for two optimized query plans, in accordance with an example embodiment herein. In the example of FIG. 6, Plan B (425) is generated using only a single parameter set (as discussed with reference to FIGS. 4 and 5) and Plan A (605) is generated using two (2) parameter sets.

In some embodiments, a cache hit area for a new point p given 2 points q₁, q₂ with the same compiled plan is defined as,

$$d ( {q}_{1} , {q}_{2} ) + T \geq e ( d ( {q}_{1} , p ) + d ( {q}_{2} , p ) )$$

where a threshold T and eccentricity e are predefined constants and distances, d, are normalized so that a cache hit algorithm or process herein can exhibit consistent performance regardless of the selectivity.

In the example of FIG. 6, Plan A (605) is generated using two (2) parameter sets for the parametrized query, where the selectivity vector of the variant filters for two (2) parameter sets are depicted at points 610 and 615 and Plan A has an associated cache hit range illustrated by ellipse 620.

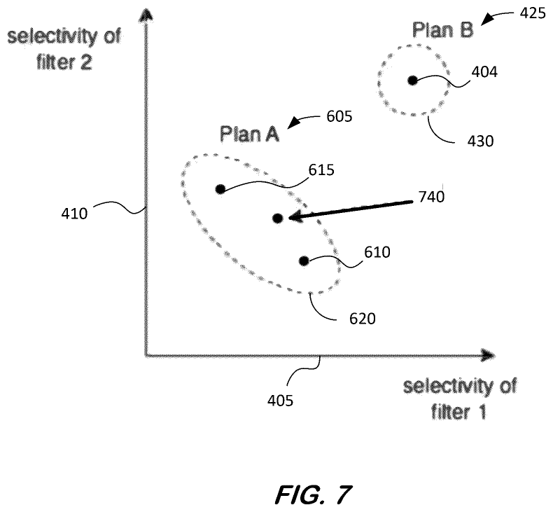

FIG. 7 is an illustrative depiction of a cache hit area for the two optimized query plans of FIG. 6 and a cache hit relative to the cached query plans, Plan A (605) and Plan B (425), for a newly received parameter set of the parameterized query, in accordance with an example embodiment herein. Accordingly, FIG. 7 demonstrates a cache hit for the newly received parameter set at 740, wherein parameter sets having a similar selectivity vector also have a similar optimal query plan and an optimal query plan for the newly received parameter set is stored in plan variant cache. For this present example, the previously cached optimal plan may be fetched from the plan variant cache and executed based on the newly received parameter set.

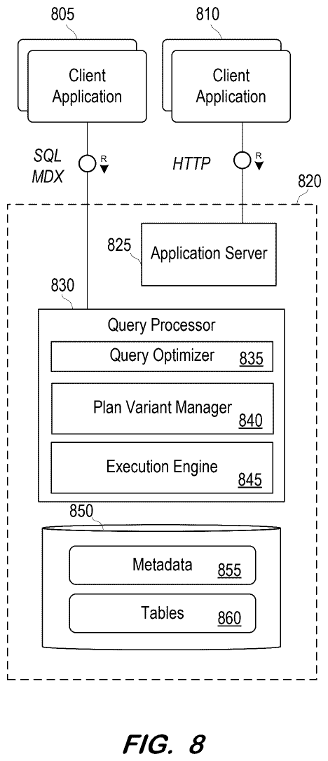

FIG. 8 is a block diagram of a database architecture which may determine pipeline execution orders for query execution plans according to some embodiments. Embodiments are not limited to the FIG. 8 architecture.

Server node 820 may receive a query from one of client applications 805 and 810 and return results thereto based on data stored within server node 820. Node 820 executes program code to provide application server 825 and query processor 830. Application server 825 provides services for executing server applications. For example, Web applications executing on application server 825 may receive Hypertext Transfer Protocol (HTTP) requests from client applications 810 as shown in FIG. 8.

Query processor 820 may include stored data and engines for processing the data. Query processor 820 may also be responsible for processing Structured Query Language (SQL) and Multi-Dimensional expression (MDX) statements and may receive such statements directly from client applications 805.

Query processor 820 includes query optimizer 835 for use in determining query execution plans, plan variant manager 840 for multiple query plans (i.e., plan variants) as disclosed hereinabove) for parameterized queries as described herein, and execution engine 845 for executing query execution plans against tables 860 of storage 850 using the determined optimized query plan for the parameterized queries. Query processor 830 may also include a statistics server (not shown) in some embodiments for determining statistics used to, for example, calculate, estimate, and determine selectivity of query predicates, including variant filters, of parameterized queries.

In some embodiments, the data of storage 860 may comprise one or more of conventional tabular data, row-stored data, column-stored data, and object-based data. Moreover, the data may be indexed and/or selectively replicated in an index to allow fast searching and retrieval thereof. Server node 820 may support multi-tenancy to separately support multiple unrelated clients by providing multiple logical database systems which are programmatically isolated from one another.

Metadata 855 includes data describing a database schema to which tables 860 conform. Metadata 855 may therefore describe the columns and properties of tables 860, the properties of each column of each table 860, the interrelations between the columns, and any other suitable information. In one example, metadata 855 may identify one or more columns of tables 860 as dictionary-compressed and include information for locating the column dictionary and dictionary indices associated with each dictionary-compressed column.

Server node 820 may implement storage 850 as an “in-memory” database, in which a full database stored in volatile (e.g., non-disk-based) memory (e.g., Random Access Memory). The full database may be persisted in and/or backed up to fixed disks (not shown). Embodiments are not limited to an in-memory implementation. For example, data may be stored in Random Access Memory (e.g., a memory for storing recently-used data) and one or more fixed disks (e.g., persistent memory for storing their respective portions of the full database).

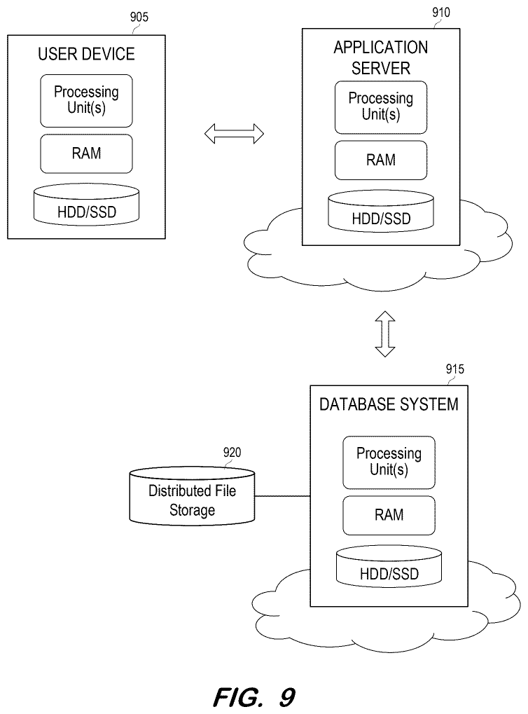

FIG. 9 illustrates a cloud-based database deployment according to some embodiments. The illustrated components may reside in one or more public clouds providing self-service and immediate provisioning, autoscaling, security, compliance and identity management features.

User device 905 may interact with applications executing on application server 910, for example via a Web Browser executing on user device 905, in order to create, read, update and delete data managed by database system 915 and persisted in distributed file storage 920. Database system 915 may store data and may execute processes as described herein to determine multiple query plans for parameterized queries and for executing the query plans on the data. Application server 910 and/or database system 915 may comprise cloud-based compute resources, such as virtual machines, allocated by a public cloud provider. As such, application server 910 and database system 915 may exhibit demand-based elasticity.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation described herein may include a programmable processor to execute program code such that the computing device operates as described herein.

All systems and processes discussed herein may be embodied in program code stored on one or more non-transitory computer-readable media. Such media may include, for example, a DVD-ROM, a Flash drive, magnetic tape, and solid state Random Access Memory (RAM) or Read Only Memory (ROM) storage units. Embodiments are therefore not limited to any specific combination of hardware and software.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

Embodiments described herein are solely for the purpose of illustration. Those in the art will recognize other embodiments may be practiced with modifications and alterations to that described above.

Based on the present disclosure, it will be apparent to persons skilled in the relevant art(s) how to make and use embodiments of the invention using data processing devices, computer systems and/or computer architectures other than that shown in FIGS. 8 and 9. In particular, embodiments may operate with software, hardware, and/or operating system implementations other than those described herein.

Although specific hardware and data configurations have been described herein, note that any number of other configurations may be provided in accordance with some embodiments of the present invention (e.g., some of the information associated with the databases and storage elements described herein may be combined or stored in external systems). Moreover, although some embodiments are focused on particular types of applications and services, any of the embodiments described herein could be applied to other types of applications and services. In addition, the displays shown herein are provided only as examples, and any other type of user interface could be implemented. Embodiments are therefore not limited to any specific combination of hardware and software.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

Embodiments disclosed herein are solely for the purpose of illustration. Those in the art will recognize other embodiments may be practiced with modifications and alterations to that described above.

1. A computer-implemented method, the method comprising:
receiving, by a processor-enabled compiler, a parameterized query;
determining, by a processor-enabled plan variant manager in response to the reception of the parameterized query, variant filters chosen from one or more predefined types of query predicates of the parameterized query, having at least a minimum influence threshold on a query plan optimization for the parameterized query;
storing, in a memory in response to determining the variant filters that exceed the minimum influence threshold, an indication of the determined variant filters associated with the parameterized query;
determining, by the plan variant manager, a selectivity of the variant filters for the parameterized query;
compiling, by the compiler in an instance of a cache miss for the parameterized query and its associated parameters with a query plan stored in a plan variant cache based on the determined selectivity of the variant filters, a compiled optimized query plan for the given parameters of the parameterized query; and
executing, by a processor-enabled query executor, an optimal query in the variant cache corresponding to the compiled optimized query plan.

2. The method of claim 1, wherein a quantity of the variant filters is limited by a predetermined value.

3. The method of claim 1, wherein the minimum influence threshold is defined by a predetermined value.

4. The method of claim 1, wherein the determining of the variant filters is based on a calculation of a probability that a data distribution for a data set for a parameterized column of a query predicate of predefined types is uniformly distributed.

5. The method of claim 4, wherein the calculation of the probability is based on database table statistics including at least one of a row count, a distinct number of elements count, a null count, and a top-k frequent elements.

6. The method of claim 1, wherein, for the parameterized query, substantially similar selectivity vectors of variant filters correspond to a substantially similar optimal query plan.

7. A system comprising:
at least one programmable processor; and
a non-transitory machine-readable medium storing instructions that, when executed by the at least one programmable processor, cause the at least one programmable processor to perform operations comprising:
receiving a parameterized query including at least one parameter;
determining a selectivity vector for variant filters associated with the parameterized query, the variant filters having at least a minimum influence threshold on a query plan optimization for the parameterized query;
determining, based on the determined selectivity vector for the variant filters associated with the parameterized query, whether there is a cache hit or a cache miss with a cached query plan and a query plan of the parameterized query;
in response to determining there is a cache hit, fetching the cached query plan and executing the cached query plan for the parameterized query; and
in response to determining there is a cache miss, compiling a compiled optimized query plan for the given parameters of the parameterized query and executing an optimal query in a variant cache corresponding to the compiled optimized query plan.

8. The system of claim 7, further comprising in response to determining there is a cache miss:
determining whether there is a cached query plan or a lack thereof corresponding to the compiled query plan for the parameterized query;
in response to determining there is a cached query plan corresponding to the compiled query plan for the parameterized query, updating a cache hit range of the cached query plan and executing the cached query plan for the parameterized query; and
in response to determining there is a lack of a cached query plan corresponding to the compiled query plan for the parameterized query, storing the compiled query plan in a memory and executing the compiled query plan for the parameterized query.

9. The system of claim 7, further comprising, in response to determining there is a cache miss, managing a cache memory for storing the compiled query plan in accordance with a predefined cache replacement policy.

10. The system of claim 9, wherein the cache replacement policy includes a least recently used process.

11. The system of claim 7, wherein the determining of whether there is a cache hit or a cache miss with a cached query plan for a query plan of the parameterized query is based on the selectivity vector for the variant filters associated with the parameterized query being within at least one region defined by pairs of selectivity vectors for the cached query plan.

12. The system of claim 7, wherein the selectivity for each of the variant filters associated with the parameterized query are determined for each parameter set provided with the parameterized query.

13. The system of claim 12, wherein the selectivity of each parameter set defines a cache hit area.

14. A non-transitory, computer readable medium storing instructions, which when executed by at least one processor cause a computer to perform a method comprising:
receiving a parameterized query including at least one parameter;
determining a selectivity vector for variant filters associated with the parameterized query, the variant filters having at least a minimum influence threshold on a query plan optimization for the parameterized query;
determining, based on the determined selectivity vector for the variant filters associated with the parameterized query, whether there is a cache hit or a cache miss with a cached query plan and a query plan of the parameterized query;
in response to determining there is a cache hit, fetching the cached query plan and executing the cached query plan for the parameterized query; and
in response to determining there is a cache miss, compiling a compiled optimized query plan for the given parameters of the parameterized query and executing an optimal query in a variant cache corresponding to the compiled optimized query plan for the parameterized query.

15. The medium of claim 14, further comprising in response to determining there is a cache miss:
determining whether there is a cached query plan or a lack thereof corresponding to the compiled query plan for the parameterized query;
in response to determining there is a cached query plan corresponding to the compiled query plan for the parameterized query, updating a cache hit range of the cached query plan and executing the cached query plan for the parameterized query; and
in response to determining there is a lack of a cached query plan corresponding to the compiled query plan for the parameterized query, storing the compiled query plan in a memory and executing the compiled query plan for the parameterized query.

16. The medium of claim 14, further comprising, in response to determining there is a cache miss, managing a cache memory for storing the compiled query plan in accordance with a predefined cache replacement policy.

17. The medium of claim 16, wherein the cache replacement policy includes a least recently used process.

18. The medium of claim 14, wherein the determining of whether there is a cache hit or a cache miss with a cached query plan for a query plan of the parameterized query is based on the selectivity vector for the variant filters associated with the parameterized query being within at least one region defined by pairs of selectivity vectors.

19. The medium of claim 14, wherein the selectivity for each of the variant filters associated with the parameterized query are determined for each parameter set provided with the parameterized query.

20. The medium of claim 19, wherein the selectivity vector of each parameter set defines a cache hit area.
